(19) United States
(12) Patent Application Publication
(10) Pub. No.: US 2007/0286464 A1
(43) Pub. Date: Dec. 13, 2007

(54) System and method for capturing a fingerprint using an electronic sensor

(76) Inventors: J. K. D. Ruwan Jayanetti, Nugegoda (LK); Wasath Viraja Mudalige, Kadwatha (LK)

Correspondence Address: FAY KAPLUN & MARCIN, LLP, 15O BROADWAY, SUITE 702, NEW YORK, NY, 10038, US

(21) Appl. No.: 11/450,555

(22) Filed: Jun. 8, 2006

(51) Int. Cl. G06K 9/00

(52) U.S. Cl. 382/124

(57) ABSTRACT

Described is a system and method for capturing a fingerprint using an electronic sensor. The method comprises receiving a monochrome image of a fingerprint, comparing an attribute value of the monochrome image to a predetermined threshold value, and accepting the fingerprint for further processing when the attribute value exceeds the predetermined threshold value.

### BACKGROUND

Fingerprints are used as a means to identify an individual since they are inherently unique to the individual. Fingerprints consist of various ridges and valleys. The basic premise of using fingerprints to identify a person is to compare the ridges and valleys with prior sets of fingerprints within a database. This method of identification may be more efficiently done with a fingerprint scanner. Currently, there are two forms of fingerprint scanners: optical scanners and capacitance scanners. However, in some instances, the image captured by, for example, the finger print scanners are blank or partially blank due to varying capacitances of the fingers, improper placement of the finger, finger movement during scanning, etc.

### SUMMARY OF THE INVENTION

The present invention relates to a system and method for capturing a fingerprint using an electronic sensor. The method comprises receiving a monochrome image of a fingerprint, comparing an attribute value of the monochrome image to a predetermined threshold value, and accepting the fingerprint for further processing when the attribute value exceeds the predetermined threshold value.

The present invention relates to a system and method for capturing a fingerprint using an electronic sensor. The system comprises a receiving module that receives a monochrome image of a fingerprint, and a comparison module that compares an attribute value of the monochrome image to a predetermined threshold value. The fingerprint is accepted by the comparison module for further processing when the attribute value exceeds the predetermined threshold value.

The present invention relates to a system and method for capturing a fingerprint using an electronic sensor. The system may also comprise an image capturing means for capturing an image, a converter means for formatting the image of the fingerprint, and a processing means for comparing an attribute of the image of the fingerprint to a threshold value and for comparing the attribute of the image to a comparison value.

### DESCRIPTION OF THE DRAWINGS

FIG. 1 illustrates an exemplary embodiment of a fingerprint detection device with a display unit according to the present invention.

FIG. 2 illustrates an exemplary scan of a bad gray scale image taken from a partially captured fingerprint.

FIG. 3 illustrates an exemplary scan of a good gray scale image taken from a properly captured fingerprint.

FIG. 4 illustrates an exemplary conversion from gray scale to monochrome of the bad gray scale image taken from the partially captured fingerprint of FIG. 2.

FIG. 5 illustrates an exemplary conversion from gray scale to monochrome of the good gray scale image taken from the properly captured fingerprint of FIG. 3.

FIG. 6 illustrates an exemplary method of accepting fingerprints according to the present invention.

FIG. 7 illustrates an exemplary method for conversion into a monochrome image according to the present invention.

### DETAILED DESCRIPTION

The present invention may be further understood with reference to the following description and the appended drawings, wherein like elements are referred to with the same reference numerals. The exemplary embodiment of the present invention describes a method for capturing acceptable fingerprints using an electronic sensor. In the exemplary embodiment, the acceptability of the fingerprints is dependent upon pixel counts of one captured image and between two captured images. The pixel counts and the captured images will be discussed in detail below. The exemplary embodiments of the present invention will be described with reference to a capacitance scanner. However, those skilled in the art will understand that the principles described herein may also be applied to an optical scanner.

In the exemplary embodiments, the exemplary fingerprint detection device includes a fingerprint sensor that utilizes capacitance scanning. Capacitance scanners generate an image of ridges and valleys that make up a fingerprint using electrical currents. Those skilled in the art will understand that the point of detection for a capacitance scanner will vary from time to time depending on the nature of the finger. For example, a wet finger has a higher capacitance than a dry finger. In the circumstance of a higher capacitance finger, the scanner may detect the finger before it actually touches the sensor, thereby resulting in a poor image of the fingerprint.

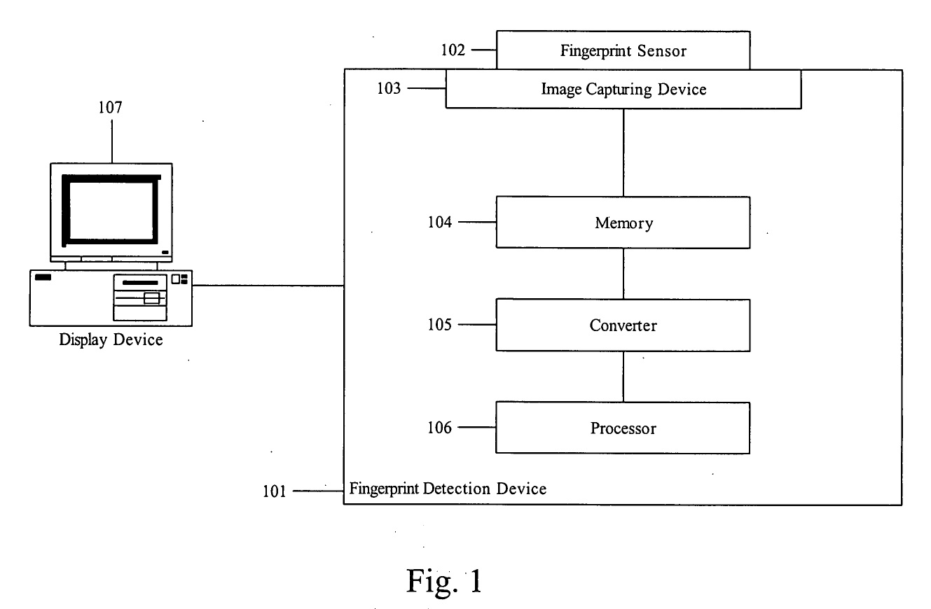

FIG. 1 illustrates an exemplary embodiment of a fingerprint detection device with a display unit according to the present invention. The fingerprint detection device 101 includes several components that are used to capture and analyze fingerprints. In addition to the various components contained in the fingerprint detection device 101, the exemplary embodiment shows a display device 107 connected to the fingerprint detection device 101 for purposes of showing the results of the scans and analyses performed by the fingerprint detection device 101. It should be noted that the display device 107 is exemplary only and that the present invention does not require a display unit since other methods of indication are available. For example, the results of the fingerprint analyses may be signaled to the user via a beeper, light emitting diode, etc., or simply by allowing the user to perform the desired function if the fingerprint is verified, e.g., open a door, log-on to a computer, etc.

The fingerprint detection device 101 is composed of a fingerprint sensor 102, an image capturing device 103, a memory 104, a converter 105, and a processor 106. It should be noted that the components described in the exemplary embodiment of the fingerprint detection device 101 are exemplary only and that other fingerprint detection devices may contain more or less components to convert a fingerprint into the necessary means for the processor to ascertain whether a valid fingerprint was captured.

The exemplary fingerprint sensor 102 includes one or more semiconductor chips containing an array of cells. Each cell includes two conductor plates covered with an insulating layer. The cells are smaller than the width of one ridge on a finger. The fingerprint sensor 102 is connected to an integrator that is an electrical circuit built around an inverting operational amplifier. The inverting amplifier is a complex semiconductor device, made up of a number of transistors, resistors, and capacitors. The inverting amplifier functions like a regular amplifier in that it alters one current based on fluctuations in another current. Specifically, the inverting amplifier alters a supply voltage. The alteration is based on the relative voltage of two inputs called the inverting terminal and the non-inverting terminal. With capacitance fingerprint sensors, the non-inverting terminal is connected to ground and the inverting terminal is connected to a reference voltage supply and a feedback loop. The feedback loop, which is also connected to the amplifier output, includes the two conductor plates. The two conductor plates form a basic capacitor. The surface of the finger (i.e., ridges of a finger) acts as a third capacitor plate, separated by the insulating layers in the cell structure. Varying the distance between the capacitor plates (i.e., by moving the finger closer or farther away from the conducting plates) changes the total capacitance (i.e., ability to store charge) of the capacitor. Thus, the capacitor in a cell under a ridge will have a greater capacitance than the capacitor in a cell under a valley.

To scan a finger, the fingerprint sensor 102 closes a reset switch for each cell that shorts each amplifier's input and output to balance the integrator circuit. Upon opening the switch, a fixed charge is applied to the integrator circuit that leads to the capacitors charging up. The capacitance of the feedback loop's capacitor affects the voltage at the amplifier's input, which affects the amplifier's output. As discussed above, since the distance to the finger alters capacitance, a finger ridge will result in a different voltage output than a finger valley. The fingerprint sensor 102 reads the voltage output and determines whether it is characteristic of a ridge or a valley. By reading every cell in the sensor array, an overall picture of the fingerprint may be ascertained.

After the fingerprint sensor 102 obtains an overall picture of the fingerprint, the image capturing device 103 records that image. The image capturing device 103 may be any device that is capable of taking an image and storing it into a format that is accessible for the other components of the fingerprint detection device 101. For example, the image capturing device 103 may be a digital camera, a spectrum analyzer, etc.

The image capturing device 103 stores the image of the fingerprint in a memory 104. The memory 104 stores the image as a 8-bit gray scale image. Gray scale is a range of shades of gray without any apparent color, ranging from black (i.e., total absence of transmitted or reflected light) to white (i.e., total transmission or reflection of light at all visible wavelengths). Intermediate shades of gray are represented by equal brightness levels of the three primary colors (i.e., red, green, blue) for transmitted light, or equal amounts of three primary pigments (i.e., cyan, magenta, yellow) for reflected light. The memory 104 may also store subsequent images that may be converted into different image formats by the converter 105. The storing of subsequent images will be described in detail below.

In the case of transmitted light, the brightness levels of the red (R), green (G), and blue (B) components are each represented as a number from decimal 0 to 255, or 00000000 to 11111111 in binary. For every pixel in a R-G-B grayscale image, the values of R, G, and B are equal (i.e., R=G=B). The lightness of the gray is directly proportional to the number representing the brightness levels of the primary colors. Thus, black is represented by R=G=B=0 or R=G=B=00000000, in binary. Also, white is represented by R=G=B=255 or R=G=B=11111111, in binary. Because there are 8 digits in the binary representation of the gray level, this imaging technique is aptly called 8-bit gray scale imaging.

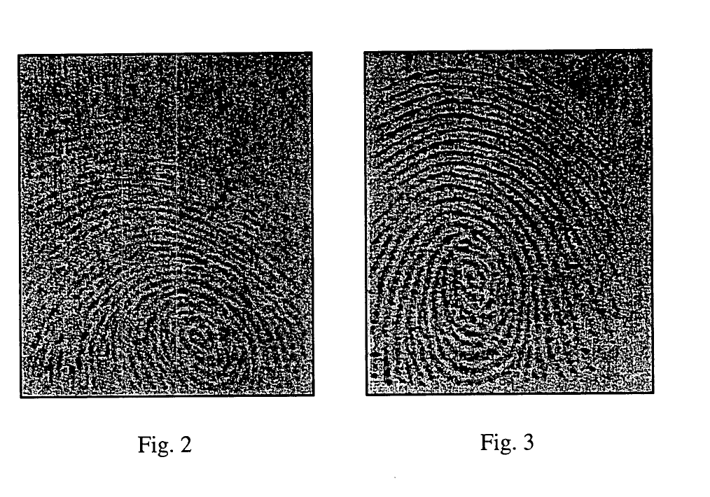

For example, FIG. 2 illustrates an exemplary scan of a bad gray scale image taken from a partially captured fingerprint. The captured fingerprint is partially captured, because capturing took place before the finger was properly placed and/or stationary on the fingerprint sensor 102. In contrast, FIG. 3 illustrates an exemplary scan of a good gray scale image taken from a properly captured fingerprint. Due to improper contact between the sensor and the finger and/or the movement of the finger when the sensor captured the image, the contrast and clarity of the captured image of FIG. 2 is less than that of the captured image of FIG. 3. To capture a good image of a fingerprint, the finger should be in good contact with the fingerprint sensor 102 and it should be held stationary on the fingerprint sensor 102.

Once the fingerprint image is stored in the memory 104 as a 8-bit gray scale image, the converter 105 accesses that image. The converter 105 converts the 8-bit gray scale image into a monochrome image. A monochrome image is an image displayed in a single color or shades of a single color. In the present invention, the single shade of color used is white. Those of skill in the art will understand that other colors may be used in a monochrome image and most displays use white, green, or amber, although it could be any color. The monochrome images may also be stored in the memory 104 if a user wishes to maintain a database, keep the images for future analyses, etc.

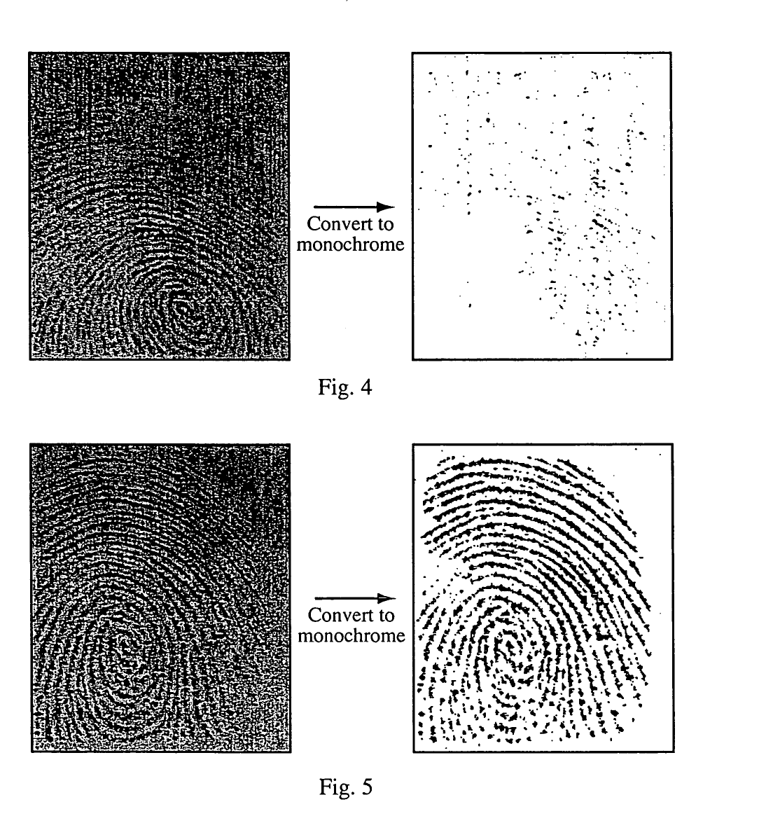

For example, FIG. 4 illustrates an exemplary conversion from gray scale to monochrome of the bad gray scale image taken from the partially captured fingerprint of FIG. 2. As shown in FIG. 4, FIG. 2 does not contain a sufficient capture of the fingerprint because the conversion into monochrome results in very few pixels. In contrast, FIG. 5 illustrates an exemplary conversion from gray scale to monochrome of the good gray scale image taken from the properly captured fingerprint of FIG. 3. As shown in FIG. 5, FIG. 3 does contain a sufficient capture of the fingerprint because the conversion into monochrome results in an adequate number of pixels that resembles the 8-bit gray scale image. It should be noted that the number of converted pixels into monochrome depends on the fingerprint sensor 102, the converter 105, and the respective qualities of those units, e.g., dots per inch, pixel size, etc.

Once the 8-bit gray scale image stored by the memory 104 is converted into a monochrome image by the converter 105, the processor 106 determines whether the captured image of the fingerprint is acceptable. The method that the processor 106 accomplishes the task of determining whether the image of the fingerprint is acceptable will be discussed in detail below.

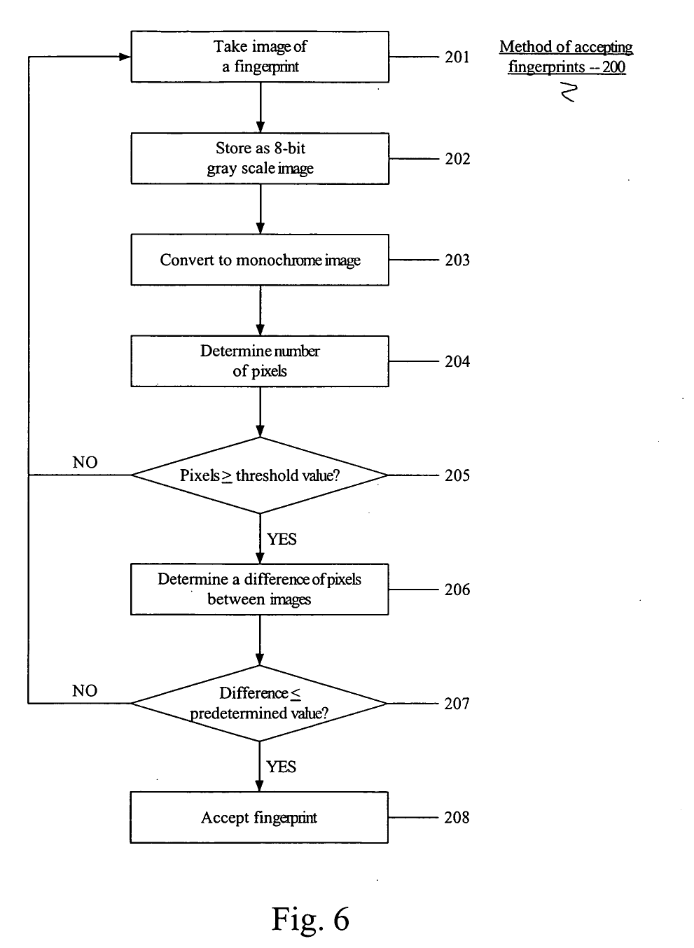

FIG. 6 illustrates an exemplary method of accepting fingerprints according to the present invention. The exemplary embodiment of the present invention uses at least two images of one fingerprint in order to authenticate that the fingerprint sensor 102 has captured an acceptable fingerprint image. However, it should be noted that the use of two images of the same fingerprint is exemplary only and that it is possible (using the inventive method) to authenticate a fingerprint with one image, for example, using scans from a previously stored image in the memory 104, using a control image for the different types of fingerprints, etc.

In step 201, the method begins by taking images of one fingerprint (i.e., consecutive fingerprints). It should be noted that a user may take multiple images in excess of two for various reasons, for example to store duplicate copies of a set of fingerprints, in preparation for further fingerprint analyses, etc. For this exemplary embodiment, in preparation for subsequent steps, the consecutive images that are taken are done within a short period of time and preferably without releasing the finger from the fingerprint sensor 102, as will be discussed below. This may further ensure the efficiency of the authentication process as fewer trials may be necessary. However, it should be noted that the consecutive images do not require them to be taken back to back nor without releasing the finger depending on the capabilities and accuracy of the fingerprint detection device and user preference.

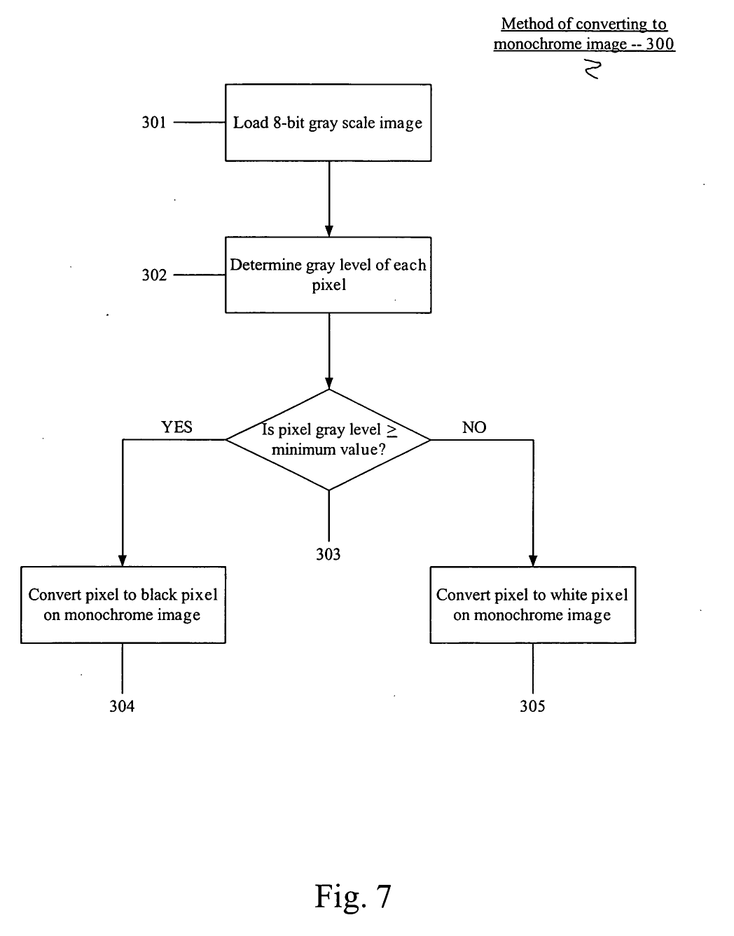

The method continues in step 202 as the image is stored as a 8-bit gray scale image, as discussed above. The conversion into a 8-bit gray scale image allows for a convenient mode to convert the image into a monochrome image as discussed above and as depicted in step 203. The conversion of the 8-bit gray scale image into the monochrome image will be discussed in detail below with reference to FIG. 7. The conversion into the monochrome image allows a processor (i.e., processor 106) to ascertain the number of pixels that exist on the monochrome image, as depicted in step 204.

This portion of the method of accepting fingerprints is dependent on the number of pixels that exist per image. Thus, in step 204, after the actual number of pixels is counted from the conversion to the monochrome image in step 203, the processor 106 determines if the number of pixels is greater than or equal to a threshold value. The threshold value that is used may be determined experimentally to keep the value at a minimum to ensure that an acceptable fingerprint image was taken. For example, by calculating an average value of the number of pixels that exist for a good fingerprint image from a sufficient sampling of acceptable fingerprint images, the value may be derived. Further, the value may be in the form of a percentage (e.g., 25%) that takes the number of converted pixels over the total pixels. This value may be translated to correlate to other fingerprint scanners that have different qualities of image capture (e.g., dots per inch, pixel size, etc.).

If the threshold value is not met, then the image does not have enough converted pixels from the 8-bit gray scale image which further means that the fingerprint sensor 102 was not able to capture an acceptable image. In this case, the method rejects the image and returns to step 201 in order for the fingerprint detection device 101 to retake the image of the fingerprint. If there are a sufficient number of pixels, then the method proceeds to step 206. In addition, in order to prepare for the remaining steps of this method, any qualifying image of the fingerprint that has enough pixels may be stored in the memory 104 so that the fingerprint sensor 102 does not have to make duplicate images. However, it should be noted that depending on the user's preference, the process may be started anew so that the subsequent steps of this method will not require multiple, unnecessary trials.

FIG. 7 illustrates a detailed description of an exemplary method for converting a 8-bit gray scale image into a monochrome image according to the present invention as was discussed in step 203 of FIG. 6. In step 301, the converter 105 loads the 8-bit gray scale image stored in the memory 104. As discussed above the 8-bit gray scale image is an image with different shades of gray depending on the amounts of primary colors for each point on an image. Certain points on an image may have darker gray shades while other points may have lighter gray shades. For example, a range may be used to determine the amount of gray at a distinct point on an image such as 0% indicating white and 100% indicating black with in between percentages indicating some shade of gray where the higher percentage equates to a darker shade of gray. Thus, in step 302, the gray level of each point or pixel is determined.

In step 303, a determination is made whether the gray level of the pixel is greater than or equal to a minimum value. The minimum value that is used may be determined experimentally to keep the value at a minimum to ensure that an acceptable fingerprint was taken. For example, using the gray scale range discussed above, the minimum value may be 50%. If the gray level is less than the minimum value, then the pixel is converted into a white pixel on the resulting monochrome image, as depicted in step 305. Otherwise, the pixel is converted into a black pixel on the resulting monochrome image, as depicted in step 304. Using white as the shade, the monochrome image is formed from the original image of the fingerprint taken by the fingerprint sensor 102. Those skilled in the art will understand that this algorithm for converting a 8-bit gray scale image to monochrome is mathematically simple and would not require a large amount of processing power; thus, allowing this algorithm to be implemented inside, for example, low end processors.

Returning to the method 200 of FIG. 6, if the image of the fingerprint contains enough black pixels as determined by step 205, then the method may continue on to step 206. As mentioned above, for this exemplary embodiment of the present invention, two images of a fingerprint are used to determine if an acceptable image of the fingerprint is taken. However, it should again be noted that those skilled in the art will understand that the use of two images is only exemplary.

In step 206, a difference is found between the number of pixels of two images of one fingerprint. As discussed above, the data pertaining to the images may be retrieved from the memory 104 if stored there. The processor 106 further takes this value to authenticate that the image of the fingerprint is acceptable. This comparison value (i.e., difference) is used to check the motion of the finger against the fingerprint sensor 102. There may be various reasons why the motion of the finger even in a short time frame alters the image. For example, the finger may press harder from one image being taken to another which may change the distance from one ridge to another ridge, the finger may move in between the images being taken, etc. This further check allows more accurate authentication of a genuine fingerprint so that the method does not solely depend on the number of pixels that are captured.

In order to check the stability, the number of black pixels in two consecutive fingerprints is compared. If a first fingerprint image's pixels are denoted as Pₙ and a second fingerprint image's pixels are denoted as Pₙ₋₁, then Pₙ≈Pₙ₋₁ since the pixels of the images of one fingerprint should be nearly identical. This relationship is used to verify the stability of the finger and may be modified with the following. Assuming K is any natural number and also the experimentally derived predetermined value that the difference must be less than or equal to, then Pₙ₋₁=Pₙ±K. Rearranging, Pₙ₋₁−Pₙ=±K. Because the difference must be less than or equal to the value of K, it may be rearranged as follows: −K<(Pₙ₋₁−Pₙ)<K. Simplifying using absolute values, the following range may be obtained: |Pₙ₋₁−Pₙ|<K. Thus, if the value of the difference is less than or equal to the experimentally derived, predetermined value, then the method ends at step 208 where the image of the fingerprint is accepted. Otherwise, the method returns to step 201 where images of the fingerprint are taken again and before returning to step 206, the retaken images must again satisfy the prerequisite of containing enough pixels (i.e., step 205).

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving a monochrome image of a fingerprint;
comparing an attribute value of the monochrome image to a predetermined threshold value; and
accepting the fingerprint for further processing when the attribute value exceeds the predetermined threshold value.

2. The method of claim 1, further comprising:
comparing the attribute value to a comparison value; and
accepting the fingerprint for further processing when the attribute value is within a predefined range of the comparison value.

3. The method of claim 1, wherein the attribute value is a number of pixels in the monochrome image.

4. The method of claim 1, wherein the predetermined threshold is based on a number of acceptable fingerprints.

5. The method of claim 1, further comprising:
rejecting the fingerprint for further processing when the attribute value is less than the predetermined threshold value; and
requesting a further monochrome image of the fingerprint.

6. The method of claim 2, wherein the comparison value is a corresponding attribute value from a further monochrome image of the fingerprint.

7. The method of claim 1, further comprising:
capturing an image of the fingerprint, the image being in a format different from the monochrome image.

8. The method of claim 7, wherein the image is captured by a capacitance scanner.

9. The method of claim 7, further comprising:
converting the captured image into the monochrome image.

10. The method of claim 7, wherein the format is a 8-bit grayscale image.

11. A system, comprising:
a receiving module receiving a monochrome image of a fingerprint; and
a comparison module comparing an attribute value of the monochrome image to a predetermined threshold value, the comparison module accepting the fingerprint for further processing when the attribute value exceeds the predetermined threshold value.

12. The system of claim 11, further comprising:
a further comparison module comparing the attribute value to a comparison value, the further comparison module accepting the fingerprint for further processing when the attribute value is within a predefined range of the comparison value.

13. The system of claim 11, wherein the attribute value is a number of pixels in the monochrome image.

14. The system of claim 11, wherein the predetermined threshold is based on a number of acceptable fingerprints.

15. The system of claim 12, wherein the comparison value is a corresponding attribute value from a further monochrome image of the fingerprint.

16. A system, comprising:
an image capturing means for capturing an image of a fingerprint;
a converter means for formatting the image of the fingerprint; and
a processing means for comparing an attribute of the image of the fingerprint to a threshold value and comparing the attribute of the image to a comparison value.

17. The system of claim 16, further comprising:
a memory means for storing the image of the fingerprint.

18. The system of claim 16, wherein the image capturing means captures the image as a 8-bit gray scale image.

19. The system of claim 16, wherein the converter means formats the image to a monochrome image.

20. The system of claim 16, wherein the image capturing means captures a second image of the fingerprint, the converter means formats the second image and the processing means derives the comparison value from a corresponding attribute of the second image.
